(19) United States
(12) Patent Application Publication
(10) Pub. No.: US 2026/0161657 A1
(43) Pub. Date: Jun. 11, 2026

(54) SYSTEM AND METHOD FOR PERIOD APPROXIMATION FOR IRREGULAR TIME SERIES THROUGH MAXIMIZATION OF TIME SERIES CHARACTERISTICS

(71) Applicant: ORACLE INTERNATIONAL CORPORATION, Redwood Shores, CA (US)

(72) Inventors: Dipawesh Pawar, Bengaluru (IN); Vipul Garg, Bengaluru (IN); Krishnan Ramanathan, Bengaluru (IN)

(21) Appl. No.: 18/973,550

(22) Filed: Dec. 9, 2024

(51) Int. Cl. G06F 16/25; G06F 16/28

(52) U.S. Cl. CPC G06F 16/254

(57) ABSTRACT

In accordance with an embodiment, described herein are systems and methods for constructing a period approximation for an irregular time series of data, through maximization of time series characteristics. When assessing a time series of data that has highly variable posting intervals, traditional approaches that rely on mean or mode calculations to estimate the (time series) period can result in period estimates that are misaligned with the actual characteristics of the data. In accordance with an embodiment, the system operates to assess different interval period values, construct a time series for each candidate period, and evaluate their characteristics such as length and population. The system can then determine a time series model based on one or more constructed time series, where the overall characteristics of an input time series are maintained, for use in data analytics, display as time series information within a user interface or dashboard, or other purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for constructing a period approximation for an irregular time series of data, through maximization of time series characteristics.

### BACKGROUND

In the field of data analytics, the use of time series forecasting to analyze an amount of data typically requires the data points to be collected at regular intervals. Common examples of such time series include electricity consumption data recorded on a monthly basis, e-commerce sales data collected daily, or income tax data gathered annually.

In many real-world applications, the temporal attributes associated with a particular set of data are inherent and facilitate accurate analysis and forecasting. However, there are other situations where the data points are not available at regular posting intervals, but instead are presented on an irregular basis, which complicates the data analytics or forecasting process.

For example, in business operations, payments to an organization may be realized according to various timelines, with corresponding transactions initially recorded as accruals. The accruals data represents amounts that have been earned, but not yet paid to an organization and are posted to the general ledger when the deals are finalized. In the interim however, the accruals represents an irregular time series of data, with irregularly spaced data points.

One approach to handling such irregularly spaced data points is to aggregate the data points into fixed windows of time, such as monthly or quarterly, before applying time series forecasting techniques. This can be an effective approach if the posting intervals are consistent and predictable.

However, in the context of an irregular time series of data, such as accruals, the posting intervals may vary significantly, not only across different categories of accruals but also among different customers.

Consequently, determining an appropriate granularity for aggregating accruals is challenging. Without accurately identifying posting intervals inherent in the data, deploying a forecasting solution is impractical; while naively aggregating data into fixed windows of time without considering the true posting intervals would reduce the overall quality of the data analytics.

### SUMMARY

In accordance with an embodiment, described herein are systems and methods for constructing a period approximation for an irregular time series of data, through maximization of time series characteristics.

When assessing a time series of data that has highly variable posting intervals, traditional approaches that rely on mean or mode calculations to estimate the (time series) period can result in period estimates that are misaligned with the actual characteristics of the data.

In accordance with an embodiment, the system operates to assess different interval period values, construct a time series for each candidate period, and evaluate their characteristics such as length and population. The system can then determine a time series model based on one or more constructed time series, where the overall characteristics of an input time series are maintained, for use in data analytics, display as time series information within a user interface or dashboard, or other purposes.

### BRIEF DESCRIPTION OF THE DRAWINGS

FIG. 1 illustrates an example data analytics system or environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 illustrates an example irregular time series of data, in this instance an accruals process timeline, in accordance with an embodiment.

FIG. 8 illustrates a system for constructing a period approximation for irregular time series through maximization of time series characteristics, in accordance with an embodiment.

FIG. 9 illustrates an example of how the system can be used to provide period approximation for irregular time series through maximization of time series characteristics, in accordance with an embodiment.

FIG. 10 further illustrates an example of providing period approximation for irregular time series through, in accordance with an embodiment.

FIG. 11 further illustrates an example of providing period approximation for irregular time series through, in accordance with an embodiment.

FIG. 12 further illustrates an example of providing period approximation for irregular time series through, in accordance with an embodiment.

FIG. 13 further illustrates an example of providing period approximation for irregular time series through, in accordance with an embodiment.

FIG. 14 illustrates an example of an input time series and constructed period approximation or output time series, in accordance with an embodiment.

FIG. 15 illustrates another example of an input time series and constructed period approximation or output time series, in accordance with an embodiment.

FIG. 16 illustrates another example of an input time series and constructed period approximation or output time series, in accordance with an embodiment.

FIG. 17 illustrates another example of an input time series and constructed period approximation or output time series, in accordance with an embodiment.

FIG. 18 illustrates a method for constructing a period approximation for irregular time series through maximization of time series characteristics, in accordance with an embodiment.

### DETAILED DESCRIPTION

In accordance with an embodiment, described herein are systems and methods for constructing a period approximation for an irregular time series of data, through maximization of time series characteristics.

When assessing a time series of data that has highly variable posting intervals, traditional approaches that rely on mean or mode calculations to estimate the (time series) period can result in period estimates that are misaligned with the actual characteristics of the data.

In accordance with an embodiment, the system operates to assess different interval period values, construct a time series for each candidate period, and evaluate their characteristics such as length and population. The system can then determine a time series model based on one or more constructed time series, where the overall characteristics of an input time series are maintained, for use in data analytics, display as time series information within a user interface or dashboard, or other purposes.

### Data Analytics Environments

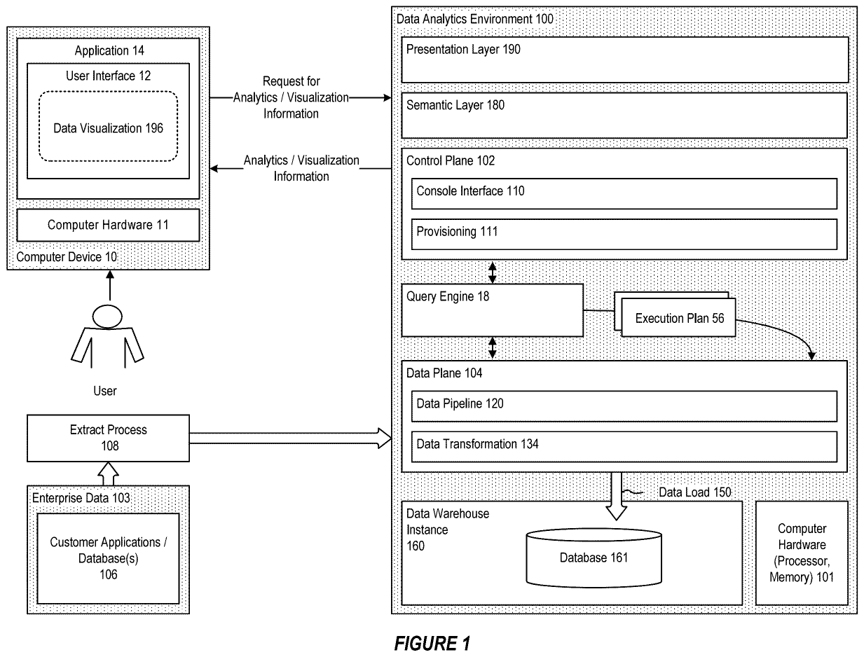

FIG. 1 illustrates an example data analytics environment, in accordance with an embodiment.

The embodiment illustrated in FIG. 1 is provided for illustrating an example data analytics environment in association with which various embodiments described herein can be used. The components and processes illustrated in FIG. 1 and as described elsewhere herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract data from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

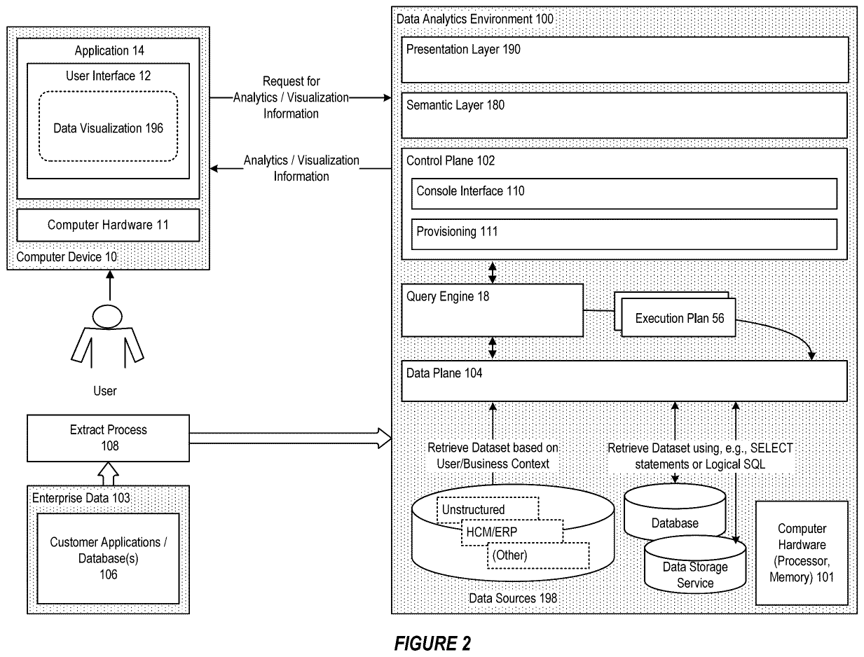

FIG. 2 further illustrates an example data analytics environment, in accordance with an embodiment.

As illustrated in FIG. 2, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

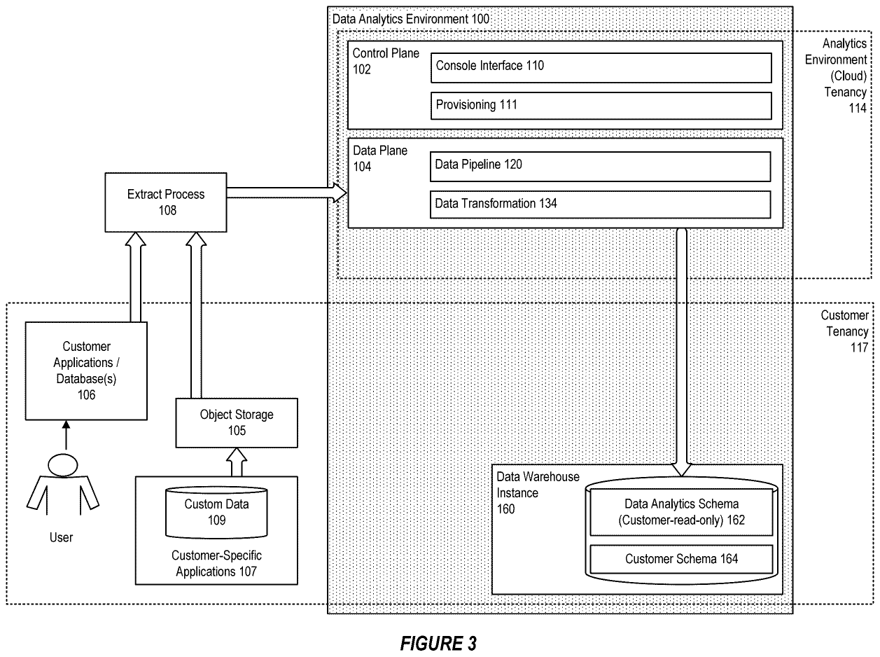

FIG. 3 further illustrates an example data analytics environment, in accordance with an embodiment.

As illustrated in FIG. 3, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

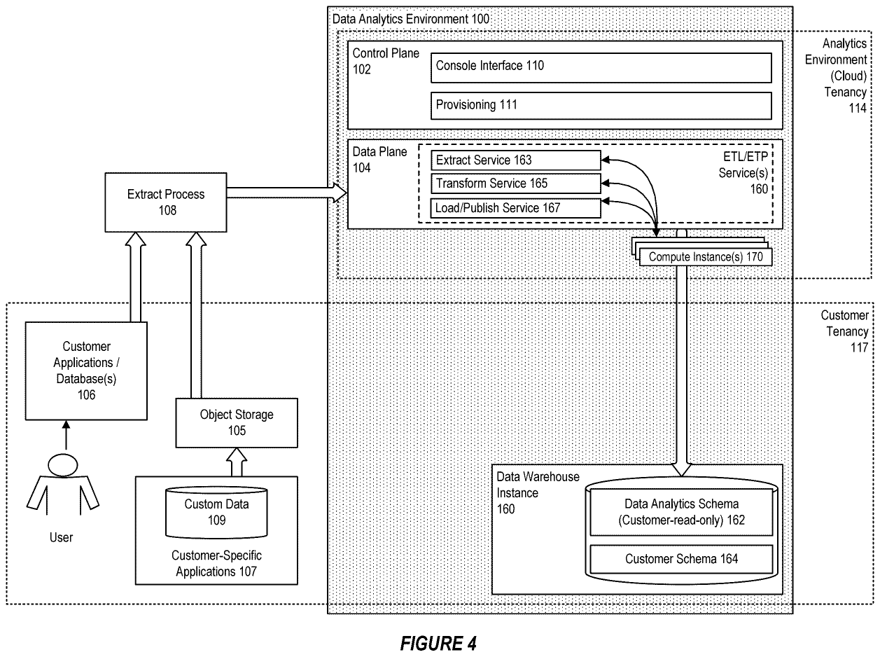

FIG. 4 further illustrates an example data analytics environment, in accordance with an embodiment.

As illustrated in FIG. 4, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

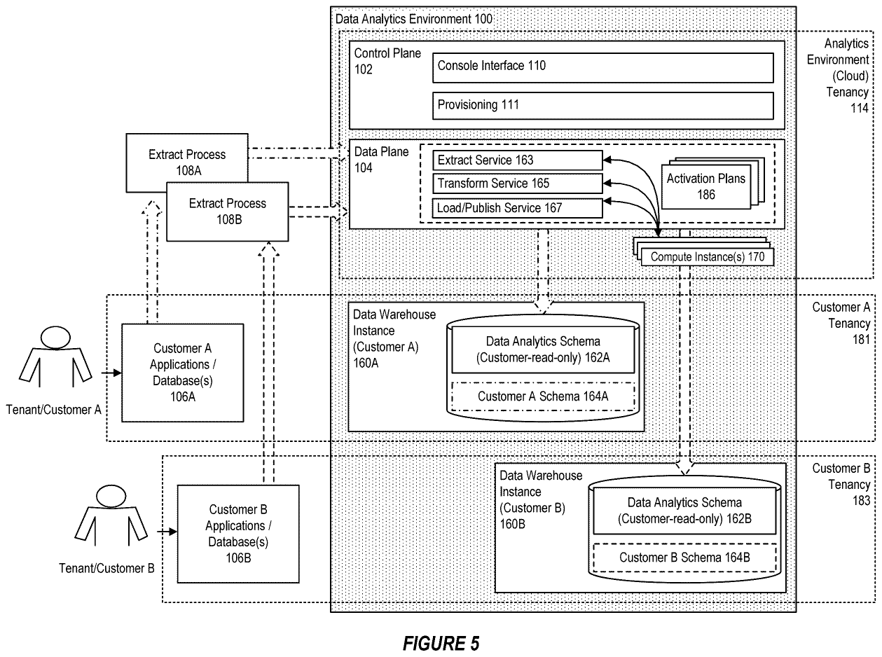

FIG. 5 further illustrates an example data analytics environment, in accordance with an embodiment.

As illustrated in FIG. 5, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

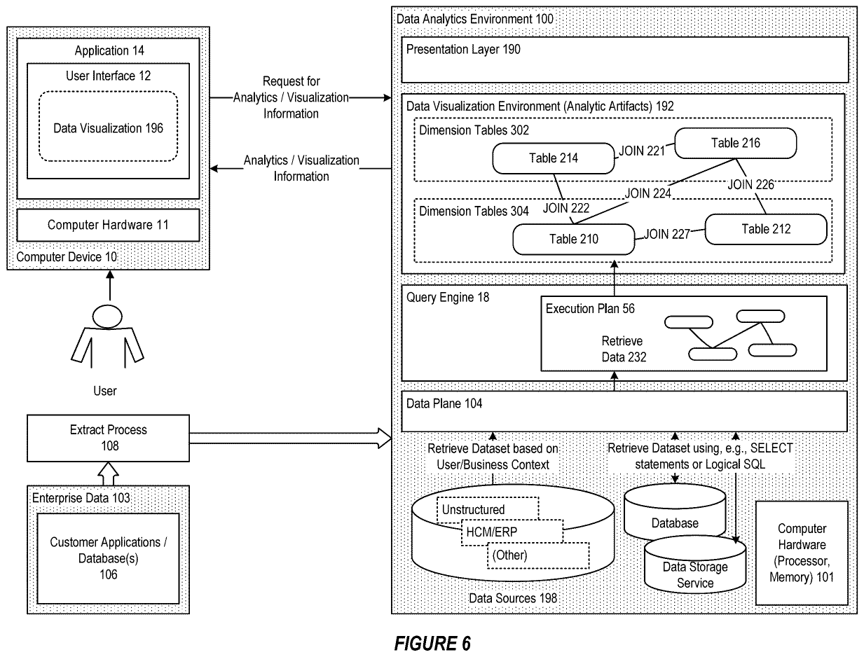

FIG. 6 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 6, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Period Approximation for Irregular Time Series

In many real-world applications, the temporal attributes associated with a particular set of data are inherent and facilitate accurate analysis and forecasting. However, there are other situations where the data points are not available at regular posting intervals, but instead are presented on an irregular basis, which complicates the data analytics or forecasting process.

For example, in business operations, payments to an organization may be realized according to various timelines, with corresponding transactions initially recorded as accruals. The accruals data represents amounts that have been earned, but not yet paid to an organization—and are posted to the general ledger when the deals are finalized. In the interim however, the accruals represents an irregular time series of data, with irregularly spaced data points.

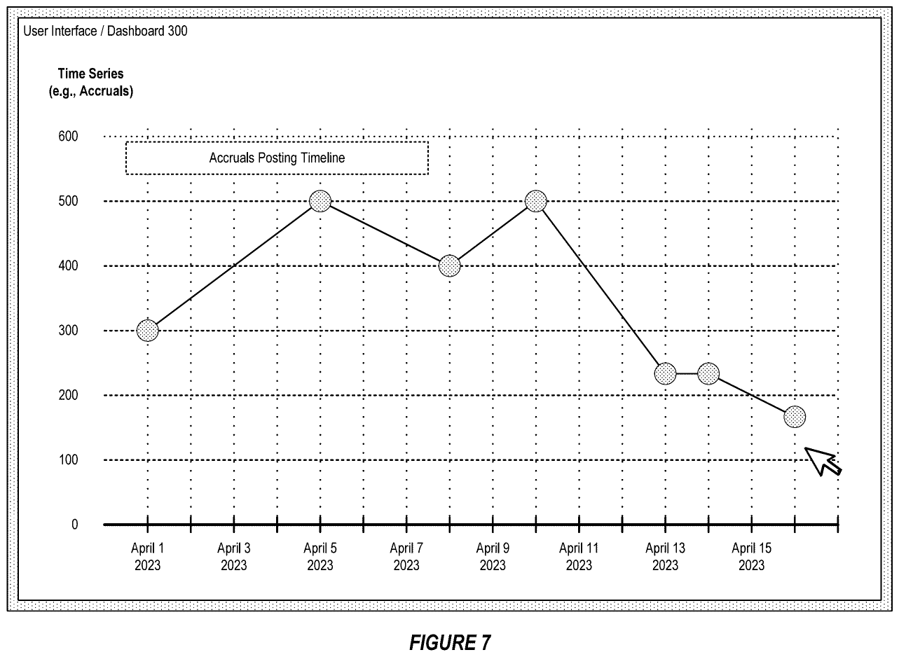

FIG. 7 illustrates an example irregular time series of data, in this instance an accruals process timeline, in accordance with an embodiment.

One approach to handling such irregularly spaced data points is to aggregate the data points into fixed windows of time, such as monthly or quarterly, before applying time series forecasting techniques. This can be an effective approach if the posting intervals are consistent and predictable.

For example, if one considers the data points shown in Table 1, the mean posting interval is 3.6 days, and the mode is 3 days.

TABLE 1

| Accruals Posting Date | Accrual Amount |
|---|---|
| Apr. 1, 2023 | $300 |
| Apr. 5, 2023 | $500 |
| Apr. 8, 2023 | $400 |

Based on these calculations, one could opt to use a 3-day interval to construct a time series, inserting a data point every three days, and assigning an accrual value of $0 for those periods in which no actual accrual data is available.

While the use of mean and mode provides a straightforward approach to standardize irregular intervals, these methods have notable disadvantages. The mean can be disproportionately influenced by higher values, especially in datasets with significant variability in posting intervals. This can lead to an overestimation of the average interval, misrepresenting the typical frequency of data points. Conversely, the mode, which represents the most frequently occurring interval, can skew the results towards values that occur with higher frequency but may not accurately capture the overall distribution of intervals.

Both methods fail to capture the true nature of the posting intervals, if the intervals are highly variable and do not exhibit consistent repetition. In such cases, relying solely on mean or mode can lead to a distorted understanding of the data's temporal structure. For example, if the posting intervals are spread across a wide range without a clear pattern, the mean may suggest an interval length that is rarely observed in practice, while the mode may overemphasize a common but not necessarily representative interval length.

Therefore, while a calculation of mean and mode provide useful tools for dealing with irregular time intervals, one must consider their limitations. When intervals vary significantly and lack regularity, these simple statistical measures may not suffice. In such scenarios, more sophisticated methods or a combination of approaches might be required to accurately capture the underlying time patterns in the data, ensuring that the forecasting model is both robust and reliable.

In accordance with an embodiment, described herein are systems and methods for constructing a period approximation for an irregular time series of data, through maximization of time series characteristics.

When assessing a time series of data that has highly variable posting intervals, traditional approaches that rely on mean or mode calculations to estimate the (time series) period can result in period estimates that are misaligned with the actual characteristics of the data.

In accordance with an embodiment, the system operates to assess different interval period values, construct a time series for each candidate period, and evaluate their characteristics such as length and population. The system can then determine a time series model based on one or more constructed time series, where the overall characteristics of an input time series are maintained, for use in data analytics, display as time series information within a user interface or dashboard, or other purposes.

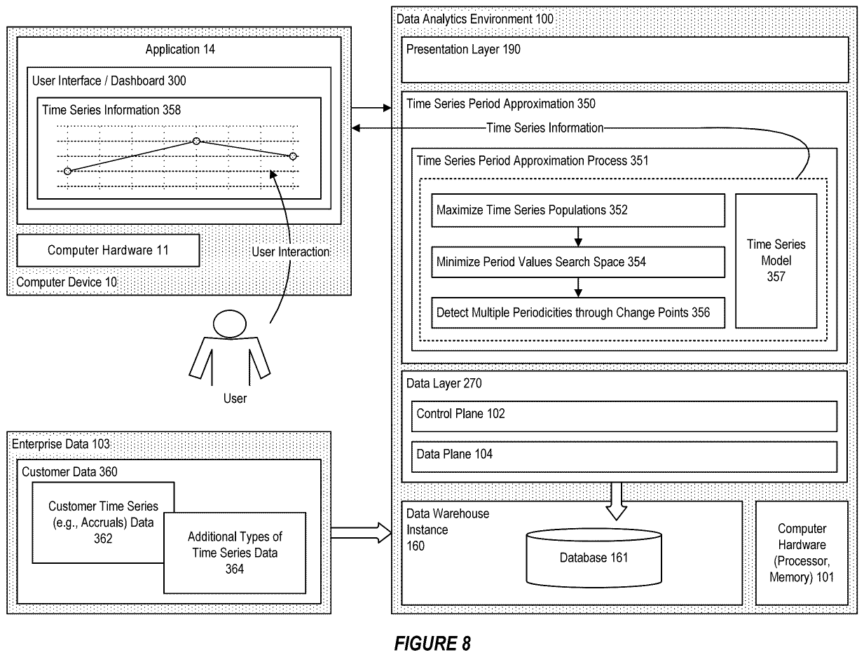

FIG. 8 illustrates a system for constructing a period approximation for irregular time series through maximization of time series characteristics, in accordance with an embodiment.

As illustrated in FIG. 8, and further described below, in accordance with an embodiment, the system can include a time series period approximation component 350 or process 352, which operates to receive as enterprise data a customer data 360, including, for example, a customer time series (e.g., accruals) data 362 and/or additional types of time series data 364.

In accordance with an embodiment, the system operates to assess different interval period values, construct a time series for each candidate period, and evaluate their characteristics such as length and population.

For example, as further described below in accordance with an embodiment, the system can include a component or process that operates to (a) maximize time series populations for accurate true period detection (352), (b) constrains or minimizes the interval period values search space through the application of lower and upper bounds (354), and (c) detect multiple periodicities through change points (356).

In accordance with an embodiment, the system can then determine a time series model 357 based on one or more constructed time series, where the overall characteristics of an input time series are maintained; and can return such time series information (358), for example for display with a user interface or dashboard 300, for use in data analytics or other purposes.

Although the examples described here generally discuss the use of accruals data as an example of an irregular time series of data, for purposes of illustration; it will be evident that the various systems, methods, and techniques described herein can be used with other types of irregular time series, to generate data analytics or other time series information associated therewith.

### Maximizing Time Series Population for Accurate True Period Detection

As described above, when assessing a time series of data that has highly variable posting intervals, traditional approaches that rely on mean or mode calculations to estimate the (time series) period can result in period estimates that are misaligned with the actual characteristics of the data.

In accordance with an embodiment, the described approach addresses this challenge by assessing different interval period values, constructing a time series for each candidate period, and evaluating the characteristics of each constructed time series, such as its length and population.

In accordance with an embodiment, as referred to herein, a “population” generally refers to the number of data points present in a constructed time series; while the “length” generally refers to the span of time covered by the time series.

As will be illustrated in the examples provided below, by constructing a time series with an interval period value K, the system will not always have an accrual value for every interval, resulting in some intervals having no data (within that constructed time series).

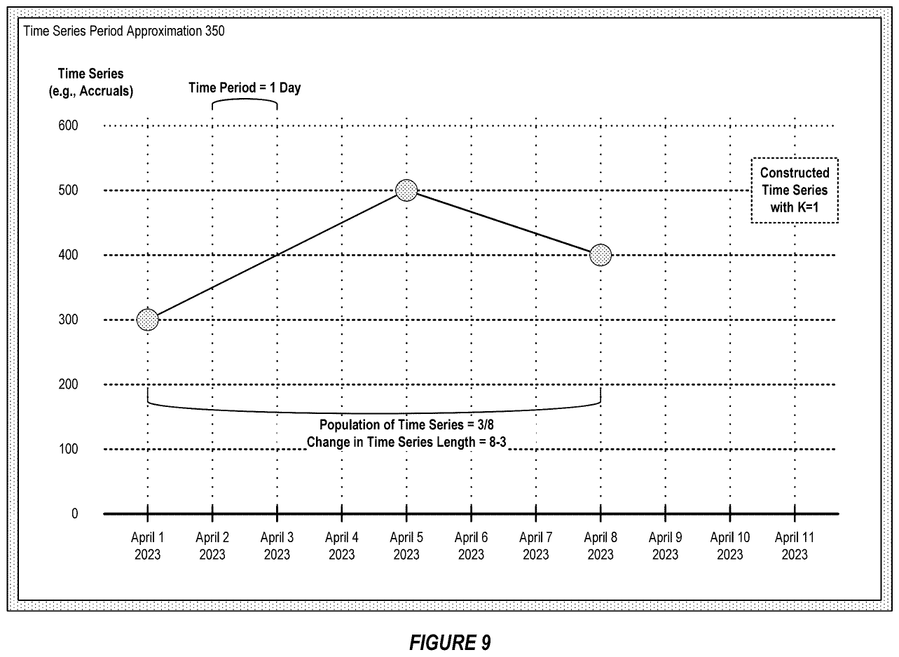

FIGS. 9-13 illustrate an example of how the system can be used to provide period approximation for irregular time series through maximization of time series characteristics, in accordance with an embodiment.

In accordance with an embodiment, the system operates to construct time series for different (time series) interval period values K=1, 2, 3, and 4, as illustrated in FIGS. 9-13 and corresponding Tables 2-4 below.

Constructed Time Series with K=1

In accordance with an embodiment, as illustrated in FIG. 9, and Table 2, the system can construct a time series for a period of 1 day. As illustrated, accrual postings are not available for empty bins.

TABLE 2

| Accruals Posting Date | Accrual Amount |
|---|---|
| Apr. 1, 2023 | $300 |
| Apr. 2, 2023 | — |
| Apr. 3, 2023 | — |
| Apr. 4, 2023 | — |
| Apr. 5, 2023 | $500 |
| Apr. 6, 2023 | — |
| Apr. 7, 2023 | — |
| Apr. 8, 2023 | $400 |

Constructed Time Series with K=2

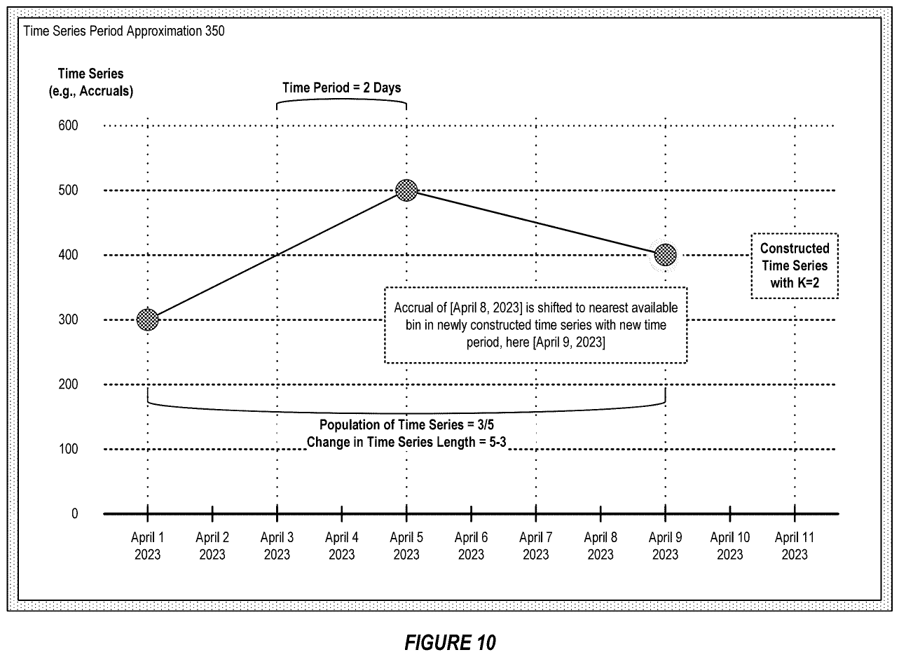

In accordance with an embodiment, as illustrated in FIG. 10, and Table 3, the system can also construct a time series for a period of 2 days. Again as illustrated, accrual postings are not available for empty bins.

In accordance with an embodiment, the accrual of [Apr. 8, 2023] is shifted to the nearest available bin in the newly constructed time series with new time period, here [Apr. 9, 2023].

TABLE 3

| Accruals Posting Date | Accrual Amount |
|---|---|
| Apr. 1, 2023 | $300 |
| Apr. 3, 2023 | — |
| Apr. 5, 2023 | $500 |
| Apr. 7, 2023 | — |
| Apr. 9, 2023 | $400 |

Constructed Time Series with K=3

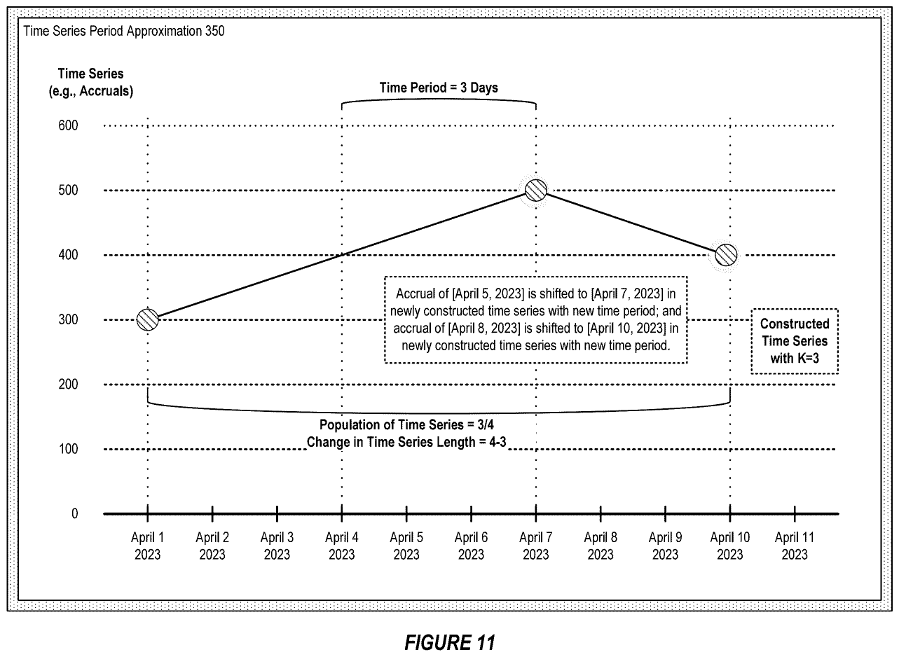

In accordance with an embodiment, as illustrated in FIG. 11, and Table 4, the system can also construct a time series for a period of 3 days. Again as illustrated, accrual postings are not available for empty bins.

In accordance with an embodiment, the accrual of [Apr. 5, 2023] is shifted to [Apr. 7, 2023] in the newly constructed time series with new time period; and the accrual of [Apr. 8, 2023] is shifted to [Apr. 10, 2023] in the newly constructed time series with new time period.

TABLE 4

| Accruals Posting Date | Accrual Amount |
|---|---|
| Apr. 1, 2023 | $300 |
| Apr. 4, 2023 | — |
| Apr. 7, 2023 | $500 |
| Apr. 10, 2023 | $400 |

Constructed Time Series with K=4

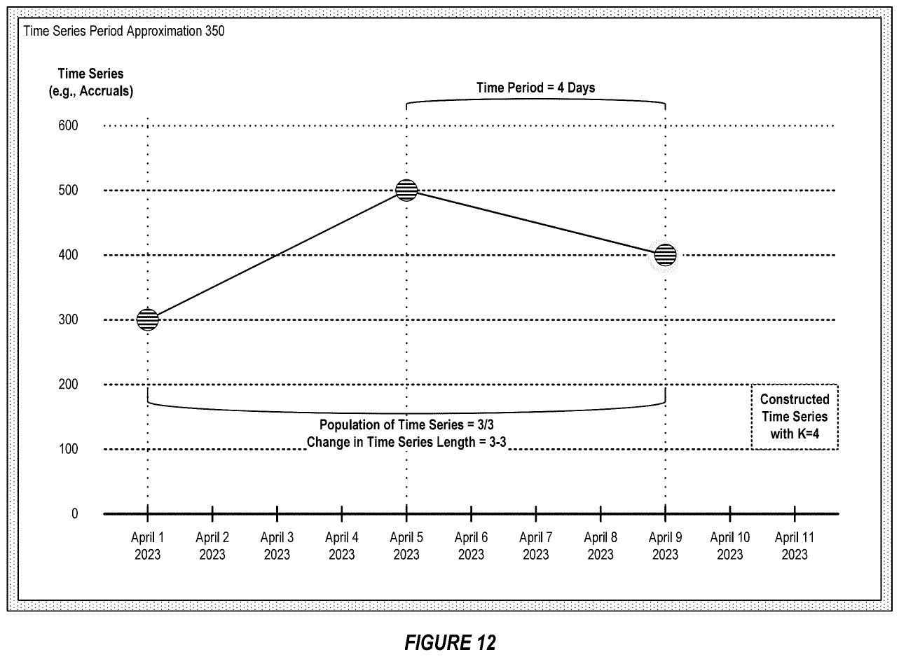

In accordance with an embodiment, as illustrated in FIG. 12, and Table 5, the system can also construct a time series for a period of 2 days.

TABLE 5

| Accruals Posting Date | Accrual Amount |
|---|---|
| Apr. 1, 2023 | $300 |
| Apr. 5, 2023 | $500 |
| Apr. 9, 2023 | $400 |

In accordance with an embodiment, it can be determined from the constructed time series that, in this example, the population (number of data points present) in a constructed time series generally increases with higher K values, while the number of empty bins of data points decreases. Conversely, the length (span of time) of the constructed time series generally decreases as K increases.

In accordance with an embodiment, the constructed time series should preferably closely match the characteristics of the original or input time series, which generally means that the length of the constructed time series should be as close to the original as possible, and the population should be maximized.

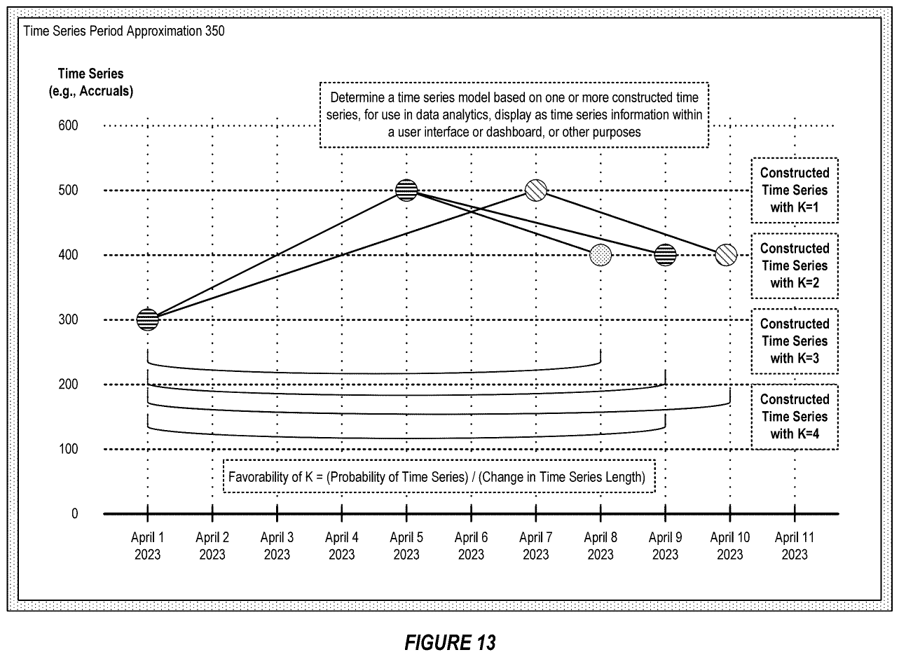

In accordance with an embodiment, the system can quantitatively determine the most suitable period K, by considering each time series' “favorability.” The favorability of a time series period K, as illustrated by way of example in FIG. 13, can be defined by the following formula or metric:

$$Favorability of K = \frac{Population of Time Series}{Change in Time Series Length}$$

Where the population of the time series is the percentage of available entries in the time series constructed with period K; and the change in time series length is the difference between the length of the original or input time series and the length of the time series constructed with period K.

In accordance with an embodiment, by applying this metric, the system can calculate the favorability of the different interval period values for the above example, as illustrated in Table 6.

TABLE 6

| Time Period K | Time Period Favorability |
|---|---|
| 1 | 3/8 * (1 / (8 − 3 + 0.001)) = (0.38 * 0.19) = 0.07 |
| 2 | 3/5 * (1 / (5 − 3 + 0.001)) = (0.60 * 0.49) = 0.29 |
| 3 | 3/4 * (1 / (4 − 3 + 0.001)) = (0.75 * 0.99) = 0.74 |
| 4 | 3/3 * (1 / (3 − 3 + 0.001)) = (1.00 * 1.00) = 1.00 |

The numbers indicated in Table 6 are intended as approximations, and are provided for illustrative purposes. A smoothening factor 0.001 is used in this example to avoid a potential division-by-zero issue.

In the illustrated example, K=4 emerges as the time series whose period most closely matches that of the original or input time series.

In accordance with an embodiment, the described approach provides a more accurate detection of the true period K by maximizing the population of the time series while minimizing the difference in length from the original time series. This results in a time series model that more accurately reflects the underlying temporal patterns, leading to improved data analytics and forecasting accuracy.

Constraint of Interval Period Values Search Space through Lower and Upper Bounds

When large data sets are involved, one of the challenges of the above approach is the extensive range of interval period values that need to be tested. In a naive implementation, one might need to try values starting from 1 up to the largest possible period interval. However, this results in a significant increase in computational complexity, which can be expressed as O(n)*p≈O(np) where n is the number of data points and p is the number of interval period values to be evaluated. In a worst-case scenario, p could be the range of the data ≈R, leading to quadratic complexity, i.e., O(nR).

In accordance with an embodiment, to mitigate this aspect, the system can operate to reduce the number of interval period values that need to be tested, by identifying appropriate lower and upper bounds for the search space of interval period values, and narrowing the range of periods to be tested.

For example, if one considers the period intervals follow a normal distribution, then statistical methods can be used to determine approximate lower and upper bounds. As defined by the empirical rule (also known as the 68-95-99.7 rule) approximately 68% of the data points lie within one standard deviation of the mean, 95% within two standard deviations, and 99.7% within three standard deviations. By applying this rule, the system can set the lower and upper bounds to be within a certain number of standard deviations from the mean of the period intervals.

For example, in accordance with an embodiment, the system can set the lower bound to be the mean period interval minus one standard deviation and the upper bound to be the mean period interval plus one standard deviation. This would on average reduce the search space to a more manageable range, thereby lowering the computational complexity of the time series period approximation process.

As an illustrative example, if one considers the mean period interval is μ, the standard deviation is σ, and R is the Range of the data. In this example, σ is less than 0.3R with a high probability. The lower bound would then be μ−σ and the upper bound would be μ+σ. By focusing its search within these bounds, the system can significantly reduce the number of interval period values that need to be evaluated.

In summary, while an approach of testing all possible interval period values can lead to computational complexity, by employing statistical techniques to define a more constrained search space allows for a more practical and efficient solution, the system maintains the integrity and accuracy of the period detection process, while also ensuring that the time series period approximation process remains computationally efficient even for larger datasets.

$$Lower bound = {{\sum }_{i = 1}}^{N - 1} ( mean ) period intervals - σ ( N - 1 period intervals )$$

$$Upper bound = {{\sum }_{i = 1}}^{N - 1} ( mean ) period intervals - σ ( N - 1 period intervals )$$

Where σ is the standard deviation. In accordance with an embodiment, in the above example, the system needs to assess only K=2, 3 and 4; and can disregard K=1.

### Multiple Periodicities Detection Through Change Points

In accordance with an embodiment, applying the above approach over chunks of data points can reveal change points in an original or input time series. Such change points are identified when the periodicity changes upon the addition of new data points, which signifies a structural change in the time series—for example, from a period of 1-day to 2-days, or from a period of 1-month to 2-months.

For example, Table 7 illustrates a company's monthly sales data over a two-year period. The system can divide the time series into quarterly chunks and apply a periodicity detection algorithm or process to detect periodicity.

TABLE 7

| Date | Sales Amount |
|---|---|
| Jan. 1, 2023 | $300 |
| Feb. 1, 2023 | $320 |
| Mar. 1, 2023 | $310 |
| Apr. 1, 2023 | $350 |
| May 1, 2023 | $370 |
| Jun. 1, 2023 | $360 |
| Jul. 1, 2023 | $400 |
| Aug. 1, 2023 | $420 |
| Sep. 1, 2023 | $410 |
| Oct. 1, 2023 | $450 |
| Nov. 1, 2023 | $470 |
| Dec. 1, 2023 | $460 |

Generally described the periodicity detection process operates according to:

```
1. Data Points = [First Data Point]
2. Periodicity Deviations = [ ]
3. Base Periodicity = None
4. Compute Periodicity
5. If Base Periodicity is None
  (a) Base Periodicity = Computed Periodicity
6. Else
  (a) If Base Periodicity != Computed Periodicity
    (i) Add Computed Periodicity to Periodicity Deviations list
    (ii) If Periodicity Deviations are stabilized
      (1) Update Base Periodicity with stabilized Computed Periodicity
      (2) Add data points for Periodicity Deviations to candidate change point block
      (3) Periodicity Deviations = [ ]
7. Data Points = Data Points + Next Available Data Point
8. Repeat from (3)
```

In accordance with an embodiment, generally described, the periodicity detection process enables the system to first determine a base periodicity associated with a time series; notice the appearance of a new periodicity in the time series; add data points associated with such changed periodicity to a candidate block; and continue to examine the time series for the presence of change points until the periodicity stabilizes.

In accordance with an embodiment, when applied to the time series in Table 7, representing an initial year of sales:
First Chunk (January 2023-March 2023): The system applies the periodicity detection process to the first three months and detects a monthly periodicity (i.e., 1 month, since sales data points are present each month).
Second Chunk (April 2023-June 2023): Moving to the next chunk, the system again detects a monthly periodicity (1 month) due to consistent monthly data points.
Third Chunk (July 2023-September 2023): In this chunk, the periodicity remains monthly (1 month, since sales data points are available every month).
Fourth Chunk (October 2023-September 2023): The system again detects a monthly periodicity (1 month).

To introduce variability and change points, the data is modified for a following year:

TABLE 8

| Date | Sales Amount |
|---|---|
| Jan. 1, 2024 | $500 |
| Mar. 1, 2024 | $520 |
| May 1, 2024 | $510 |
| Jul. 1, 2024 | $550 |
| Sep. 1, 2024 | $570 |
| Nov. 1, 2024 | $560 |

First Chunk (January 2024-March 2024): The system applies the periodicity detection process to the first three months and detects a 2-month periodicity (i.e., sales data points are available every two months).
Second Chunk (April 2024-June 2024): The periodicity changes to 2 months again, consistent with the previous chunk.
Third Chunk (July 2024-September 2024): The 2-month periodicity remains.
Fourth Chunk (October 2024-December 2024): The periodicity continues to be 2 months.

### Example Explanation

As illustrated above, in accordance with an embodiment, the system can determine, based on its time series model that:

During the Initial Year (2023): The periodicity is 1 month throughout the year, indicating consistent monthly sales.

During the Following Year (2024): The periodicity shifts to 2 months, indicating sales data points are collected every two months, revealing a change point at the start of 2024.

By identifying these change points, the system can segment the time series into intervals where distinct periodicities are present. In this case, the change point at the beginning of 2024 indicates a shift from monthly to bi-monthly sales patterns. By iteratively applying the periodicity detection process and identifying change points, the system can uncover time series information such as multiple periodicities within a particular time series. This segmentation allows for a more accurate and comprehensive analysis of the time series, facilitating improved forecasting and strategic planning.

### Example Time Series

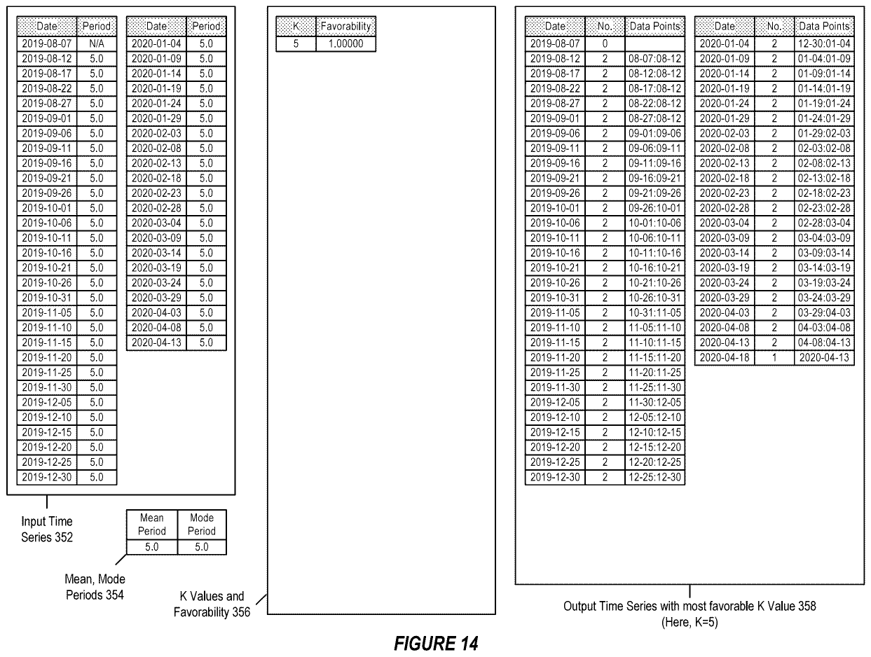

FIGS. 14-17 illustrate various examples of an input time series and constructed period approximation or output time series, in accordance with an embodiment.

As illustrated in FIGS. 14-17, an input time series 352, comprising a series of data points recorded at one or more time period intervals, can be assessed using the above described system or method, to determine a mean and mode period 354, and a set of K values and associated favorability 356.

In accordance with an embodiment, the system can then determine a time series model based on one or more constructed time series of data points, providing a period approximation or output time series 356 for the input time series, which can be subsequently used in data analytics or for other purposes.

FIG. 14 illustrates a first example, in which the data points within the input time series are available at regular intervals; the system determines a most favorable K value=5, and then proceeds to determine a time series model based on the constructed time series.

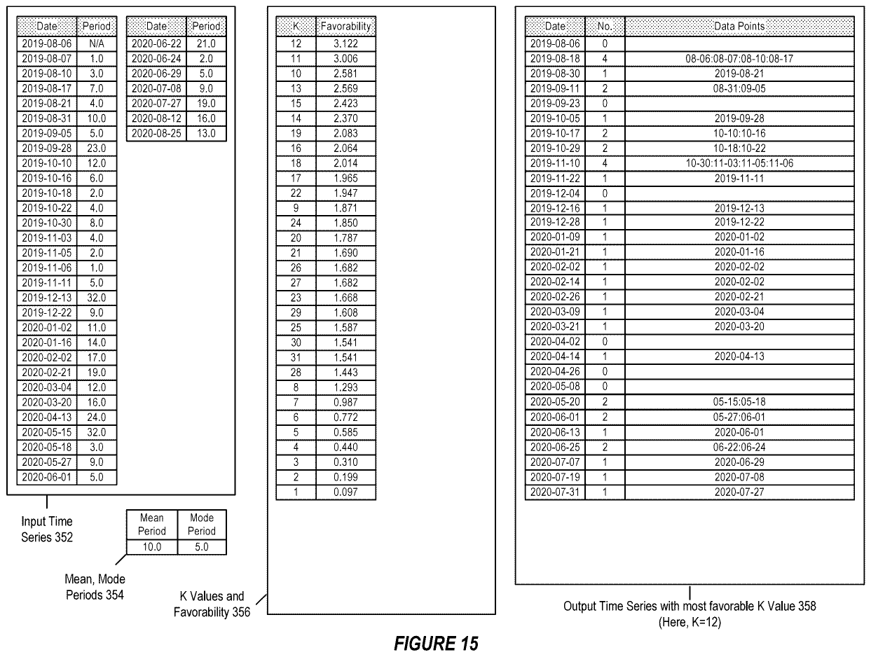

FIG. 15 illustrates a second example, in which the data points within the input time series are available at irregular intervals; the system determines a most favorable K value=12, and then proceeds to determine a time series model based on the constructed time series.

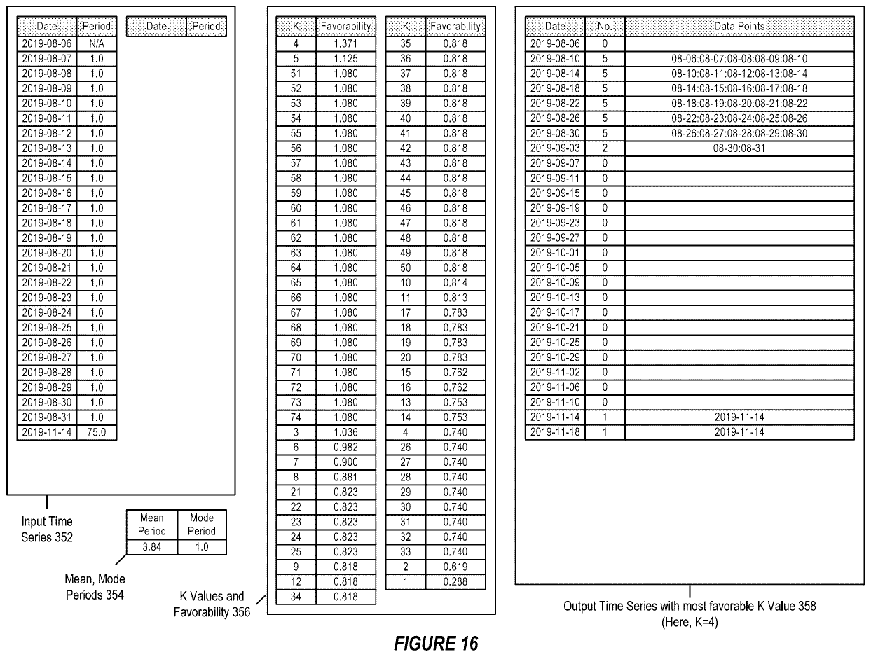

FIG. 16 illustrates a third example in which the data points within the input time series are available at regular intervals, albeit with one anomalous data point; the system determines a most favorable K value=4, and then proceeds to determine a time series model based on the constructed time series.

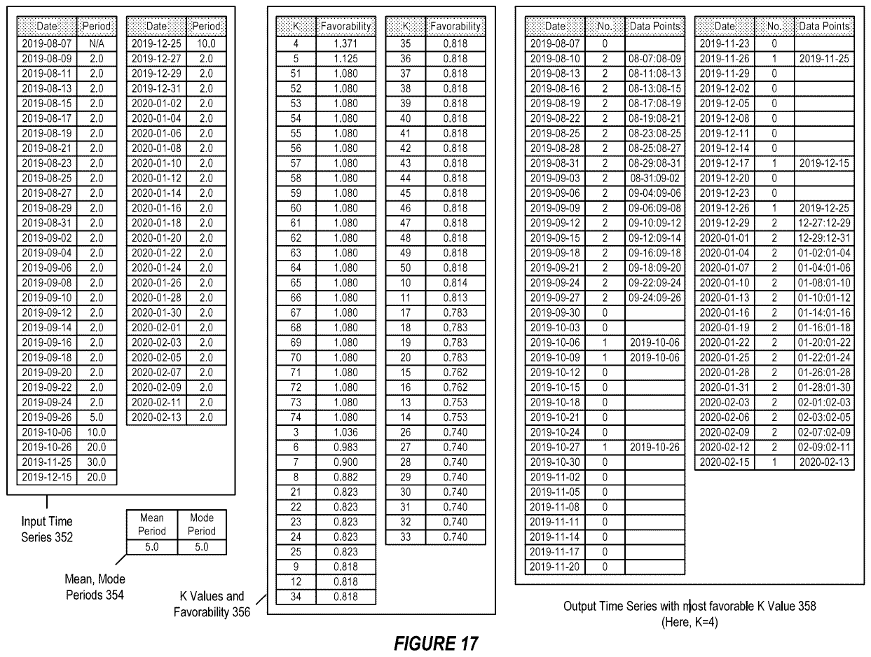

FIG. 17 illustrates a fourth example, in which the data points within the input time series are available at regular intervals, with several anomalous data points; the system determines a most favorable K value=4, and then proceeds to determine a time series model based on the constructed time series.

### Method for Constructing a Period Approximation for Irregular Time Series

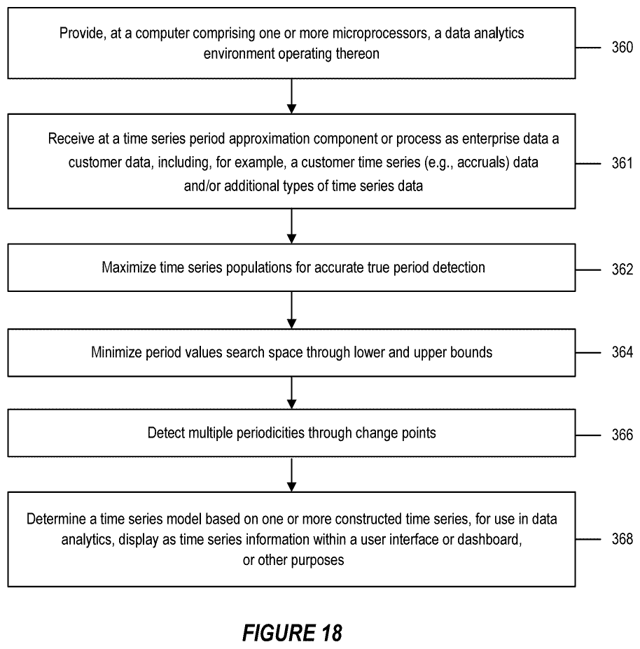

FIG. 18 illustrates a method for constructing a period approximation for irregular time series through maximization of time series characteristics, in accordance with an embodiment.

As illustrated in FIG. 18, in accordance with an embodiment, the method includes, at step 360, providing, at a computer comprising one or more microprocessors, a data analytics environment operating thereon.

At step 361, the system can receive, at a time series period approximation component or process, as enterprise data, a customer data, including, for example, a customer time series (e.g., accruals) data and/or additional types of time series data.

At step 362, the system operates to maximize time series populations for accurate true period detection.

At step 364, the system operates to minimize interval period values search space through lower and upper bounds.

At step 366, the system operates to detect multiple periodicities through change points.

At step 368, the system can then determine a time series model based on one or more constructed time series, for use in data analytics, display as time series information within a user interface or dashboard, or other purposes.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

Additionally, although the examples described here generally discuss the use of accruals data as an example of an irregular time series of data, for purposes of illustration; it will be evident that the various systems, methods, and techniques described herein can be used with other types of irregular time series, to generate data analytics or other time series information associated therewith.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

1. A system for constructing a period approximation for an irregular time series of data, through maximization of time series characteristics, comprising:
a computer comprising one or more microprocessors, and a cloud or other computing environment operating thereon, wherein the system provides a data analytics environment that includes:
a data plane that operates to perform extract, transform, and load operations, including extracting data from an enterprise software environment, transforming extracted data into a model format, and loading transformed data into a data warehouse; and
a presentation layer that provides access to data content using a user interface or dashboard wherein in response to a request received via a client application and user interface the system retrieves a dataset for use in generating and returning requested data analytics or visualization information to the client;
wherein the system performs a method comprising:
receiving a time series data;
assessing different interval period values, using a periodicity detection process to determine changes in periodicity to segment the time series data into intervals where distinct periodicities are present, constructing a time series for each candidate period, and evaluating characteristics of each candidate period including a length and population of each candidate period to determine a favorability metric for its constructed time series; and
determining a time series model based on one or more of the constructed time series, where the overall characteristics of an input time series are maintained, for use in data analytics;
wherein the time series model is used within the data analytics environment to display time series information within the user interface or dashboard.

2. The system of claim 1, wherein the method further comprises one or more of:
constraining or minimizing the interval period values search space through the application of lower and upper bounds;
identifying change points in a given time series; and/or
detecting multiple periodicities through change points.

3. The system of claim 1, wherein a time series information is returned for display within a user interface or dashboard.

4. The system of claim 1, wherein the system is provided for use with or as part of a data analytics environment.

5. The system of claim 1, wherein the system is provided for use with or as part of a cloud computing environment.

6. A method for constructing a period approximation for an irregular time series of data, through maximization of time series characteristics, comprising:
providing, at a computer comprising one or more microprocessors and a cloud or other computing environment operating thereon, a data analytics environment that includes:
a data plane that operates to perform extract, transform, and load operations, including extracting data from an enterprise software environment, transforming extracted data into a model format, and loading transformed data into a data warehouse; and
a presentation layer that provides access to data content using a user interface or dashboard wherein in response to a request received via a client application and user interface the system retrieves a dataset for use in generating and returning requested data analytics or visualization information to the client;
receiving a time series data;
assessing different interval period values, using a periodicity detection process to determine changes in periodicity to segment the time series data into intervals where distinct periodicities are present, constructing a time series for each candidate period, and evaluating characteristics of each candidate period including a length and population of each candidate period to determine a favorability metric for its constructed time series; and
determining a time series model based on one or more of the constructed time series, where the overall characteristics of an input time series are maintained, for use in data analytics;
wherein the time series model is used within the data analytics environment to display time series information within the user interface or dashboard.

7. The method of claim 6, wherein the method further comprises one or more of:
constraining or minimizing the interval period values search space through the application of lower and upper bounds;
identifying change points in a given time series; and/or
detecting multiple periodicities through change points.

8. The method of claim 6, wherein a time series information is returned for display within a user interface or dashboard.

9. The method of claim 6, wherein the method is performed with or as part of a data analytics environment.

10. The method of claim 6, wherein the method is performed with or as part of a cloud computing environment.

11. A non-transitory computer readable storage medium, including instructions stored thereon which when read and executed by one or more computers cause the one or more computers to perform a method comprising:
providing, at a computer comprising one or more microprocessors and a cloud or other computing environment operating thereon, a data analytics environment that includes:
a data plane that operates to perform extract, transform, and load operations, including extracting data from an enterprise software environment, transforming extracted data into a model format, and loading transformed data into a data warehouse; and
a presentation layer that provides access to data content using a user interface or dashboard wherein in response to a request received via a client application and user interface the system retrieves a dataset for use in generating and returning requested data analytics or visualization information to the client;
receiving a time series data;
assessing different interval period values, using a periodicity detection process to determine changes in periodicity to segment the time series data into intervals where distinct periodicities are present, constructing a time series for each candidate period, and evaluating characteristics of each candidate period including a length and population of each candidate period to determine a favorability metric for its constructed time series; and
determining a time series model based on one or more of the constructed time series, where the overall characteristics of an input time series are maintained, for use in data analytics;
wherein the time series model is used within the data analytics environment to display time series information within the user interface or dashboard.

12. The non-transitory computer readable storage medium of claim 11, wherein the method further comprises one or more of:
constraining or minimizing the interval period values search space through the application of lower and upper bounds;
identifying change points in a given time series; and/or
detecting multiple periodicities through change points.

13. The non-transitory computer readable storage medium of claim 11, wherein a time series information is returned for display within a user interface or dashboard.

14. The non-transitory computer readable storage medium of claim 11, wherein the method is performed with or as part of a data analytics environment.

15. The non-transitory computer readable storage medium of claim 11, wherein the method is performed with or as part of a cloud computing environment.
